(19) United States
(12) Patent Application Publication
(10) Pub. No.: US 2026/0267906 A1
(43) Pub. Date: Sep. 10, 2026

(54) VISUAL AGENTIC REASONING WITH TOOL USE

(71) Applicant: GDM Holding LLC, Mountain View, CA (US)

(72) Inventors: Sachit Menon, New York, NY (US); Ahmet Iscen, Seyssinet-Pariset (FR); Arsha Nagrani, Cambridge, MA (US); Tobias Christoph Weyand, Anaheim, CA (US); Cordelia Luise Schmid, Saint Ismier (FR)

(21) Appl. No.: 19/559,577

(22) Filed: Mar. 6, 2026

Related U.S. Application Data
(60) Provisional application No. 63/768,872, filed on Mar. 7, 2025.

(51) Int. Cl. G06F 16/435

(52) U.S. Cl. CPC G06F 16/435

(57) ABSTRACT

Systems and methods for effectively performing tasks using generative neural networks. In particular, this specification describes how to effectively use tools, also referred to as modules, to generate responses to queries about visual contexts.

### CROSS-REFERENCE TO RELATED APPLICATION

This application claims the benefit under 35 U.S.C. § 119 (e) of U.S. Patent Application No. 63/768,872, filed Mar. 7, 2025. The disclosure of the foregoing application is incorporated herein by reference in its entirety for all purposes.

### BACKGROUND

This specification relates to processing images using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that generates responses to queries about a “visual” context input, i.e., a context input that includes one or more images.

The subject matter described in this specification can be implemented in particular embodiments so as to realize one or more of the following advantages.

Recent advances in video understanding have been propelled by multimodal large-language models (MLLMs) trained end-to-end on visual and text inputs. While these systems have made major strides in basic perception, they often falter with queries demanding compositional, multi-step reasoning over long videos or other visual inputs that include a large number of images, that include complex images, or both.

Recently, tool-augmented inference has emerged as a powerful class of models towards achieving compositional reasoning in a variety of domains. These methods decompose a query into sub-tasks, invoke specialized modules, and scale to large contexts by selectively “zooming-in” on the relevant portion of the input given appropriate tools. These modular inference approaches offer (i) interpretable decision chains, (ii) graceful scaling as context length and task complexity grow, and (iii) a natural substrate for inference-time reasoning, as they generate structured reasoning traces by construction.

However, these approaches have not scaled to the complexity and size of video reasoning tasks in large part because they lack the ability to adapt their procedures during execution. For example, current tool-based methods typically generate fixed procedures, i.e., call tools in a fixed sequence, or use hand-designed task stages that are directly executed, i.e., split the task into a fixed sequence of task stages. Such fixed plans require meticulous prompt engineering of application programming interface (API) declarations and in-context examples, which are provided as part of the input to a language model neural network, as the plan cannot be changed once execution starts. This rigidity requires models to stitch together module outputs that they never actually observe, and systems must decide which tool to use when (and with what inputs) without having seen any cases of where the tools succeed or fail. Consequently, one poor decision snowballs into unrecoverable errors and propagates hallucinations unchecked. Video exacerbates this problem because the potential points of failure increase due to the dynamic and high-dimensional nature of video data.

This specification describes an agentic framework that addresses these issues by (i) allowing a program-generating agent to dynamically generate a sequence of executable programs as part of responding to a given query, (ii) pairing a program-generating agent with a natural-language critic, or (iii) both.

More specifically, the program-generating agent can iteratively compose video modules into sequences of executable programs, considering the result of each before moving on to the next step, enabling adaptability over the course of reasoning. It thereby generates interpretable reasoning traces that lend themselves well to verification.

The critic inspects multiple reasoning traces (“trajectories”) reflecting different solution strategies and selects the most plausible sequence, e.g., based on examples the critic has been provided with. By comparing multiple strategies, the critic enables success in cases where some approaches lead to success while others fail.

Together, the agent and critic allow the described framework to sidestep brittle tool choices and mitigate hallucinations, achieving state-of-the-art results across multiple tasks and datasets.

In sum, the described techniques have many benefits over previous modular approaches. For one, the described techniques generate trajectories that are interpretable, as each step corresponds to a short program that can be easily examined. For another, the described techniques enable scaling the performance of a single underlying model with no additional training, by simply modifying the set of modules that are available to the reasoning agent. For another, the described techniques avoid issues of customizing module selection to a particular domain, as the critic selects the most promising strategy from multiple different strategies, allowing for certain ones of the strategies to not work well for the given domain without harming overall task performance. For another, the described techniques afford compositionality without extreme hand-tuning of module definitions, as the reasoning agent can see module outputs in-context to decide how to use them to generate the next program in a given trajectory. For another, the described techniques are general, easily incorporating any additional video modules or other code that may be useful for a particular domain.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example neural network system.

FIG. 2 is a flow diagram of an example process for generating a trajectory using the reasoning generative neural network.

FIG. 3 is a flow diagram of an example process for selecting between trajectories using the critic generative neural network.

FIG. 4 shows an example of the operation of the system.

FIG. 5 shows an example of selecting between trajectories using the critic generative neural network.

Like reference numbers and designations in the various drawings indicate like elements.

### DETAILED DESCRIPTION

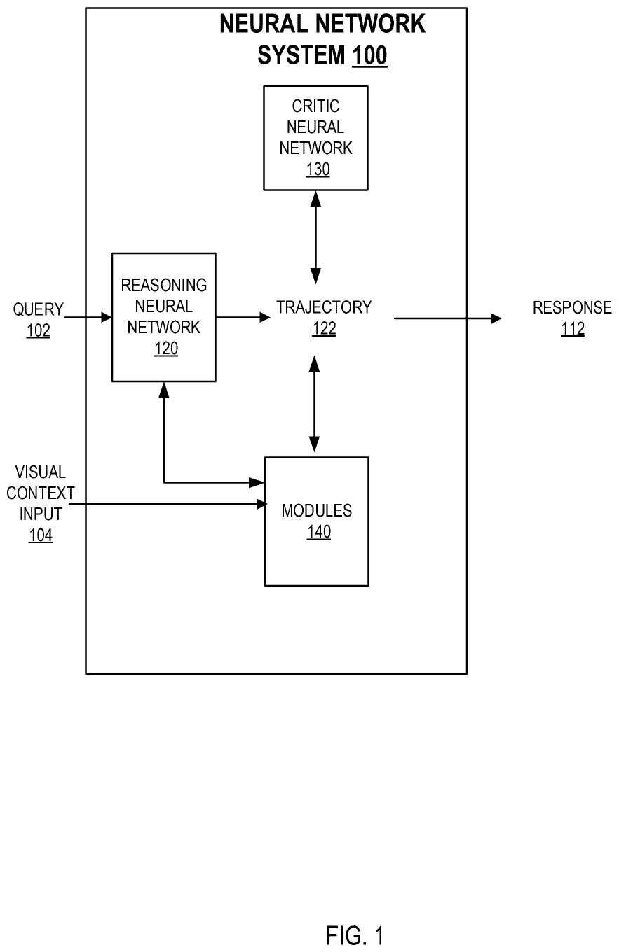

FIG. 1 shows an example neural network system 100. The neural network system 100 is an example of a system implemented as computer programs on one or more computers in one or more locations in which the systems, components, and techniques described below are implemented.

The system 100 generates responses 112 to queries 102 about a “visual” context input 104, i.e., a context input that includes one or more images.

In some cases, the context input 104 includes multiple images, e.g., includes a video that includes a temporal sequence of images or includes multiple different images of a scene captured by different cameras.

In some cases, the context input 104 can be a multi-modal context input that includes one or more images and data from another modality. As a particular example, the context input can include an audio signal, e.g., the audio soundtrack for a video that is included in the context input, or a text input, e.g., a transcription of the audio soundtrack for the video.

The query 102 can generally be any appropriate query that relates to the visual context input 104, e.g., a query relating to one or more objects depicted in the visual context input, one or more events depicted in the visual context input, one or more actions that are performed by one or more agents depicted in the visual context input, and so on. For example, when the context input 102 includes a video 104, the response can identify one or more of: (i) a time range in the video that corresponds to when an action or event, e.g., an action or event specified in the query 102, occurred; (ii) a count of events, e.g., of types of events that are specified in the query 102, in the video; or (iii) a temporal ordering of events, e.g., events that are specified in the query 102, in the video.

Thus, the response 112 generated by the system 100 can characterize any of a variety of aspects of the one or more images in the context input 104.

For example, the response 112 can be a text response that describes one or more objects depicted in the visual context input 104, that describes one or more events depicted in the visual context input 104, that describes one or more actions that are performed by one or more agents depicted in the visual context input 104, that describes low-level features of one or more of the images in the visual context input 104, and so on.

In some cases, the query 102 includes a set of possible responses and the response 112 generated by the system 100 selects one of the possible responses as the response to the query 102. In some other cases, the system 100 generates a natural language or other type of response, i.e., rather than selecting a response from a set of possible options.

More specifically, the system 100 obtains a context input 104 that includes one or more images.

The system 100 also obtains a query 102 relating to the context input. For example, the query 102 can be a text query or an audio query. As a particular example, the query 102 can be a natural language query about the context input 104, e.g., a query about one or more objects depicted in the visual context input 104.

The system 100 then generates a response 112 to the query 102 using a reasoning generative neural network 120 and, in some cases, a critic generative neural network 130. The reasoning generative neural network 120 and the critic generative neural network 130 can also be referred to as a reasoning “agent” and a critic “agent,” respectively.

The reasoning generative neural network 120 and the critic generative neural network 130 can be the same generative neural network (but with different prompts that cause the generative neural network to generate different types of outputs) or different generative neural networks (e.g., generative neural networks having the same architecture but trained differently or generative neural networks having different architectures and trained differently).

Examples of architectures of the generative neural networks are described below.

The reasoning generative neural network 120 generates, as output, programs, i.e., computer programs in a specified programming language, that call one or more of a set of modules 140.

The modules 140 are software tools that can be queried by the system 100 to obtain an output or executed by the system to obtain an output. The modules 140 generally include “visual” modules that operate on the context 104 and, in some cases, modules that do not operate on the context 104. Examples of visual modules 140 that operate on the context 104 include a visual retrieval module, a temporal grounding module, and an automatic speech recognition (ASR) understanding module.

Some specific examples of visual modules now follow.

One example of a visual module is a visual retrieval module. One of the most fundamental capabilities needed to understand long videos is the ability to obtain the most visually relevant frames to a given query and use them to get the information corresponding to said query. Retrieval of relevant frames also allows for further intermediate interpretability via visual inspection. For example, this tool can perform this retrieval by prompting a multi-modal model, e.g., the reasoning generative neural network or another multi-modal generative neural network, with a sliding window of the frames up to the limit of its context window. At a high level, the tool can use the visual capabilities of the underlying model to directly ask which individual frames are visually relevant in the given window; the identified frames are then considered to respond to the query.

Another example of a visual module is a temporal grounding module. Aside from considering the relevant portion of a video based on its visual content, another important ability is to ground temporal information to the video—that is, select the most relevant part of the video based on explicit times. Given a start and end timestamp (and the frame rate for any input video as given), this tool allows the agent to use temporal information in this way by simply trimming out the relevant segment. This can also enable better interpretability in knowing which part of the video the agent chose to consider.

Another example of a visual module is a temporal localization module. Given a query corresponding to an event or action, this module aims to determine potential ranges of time (identified by a start timestamp and an end timestamp) that may correspond to the given query along with a brief description of what led it to output each range. If the video is longer than the context length available, this module also employs a windowed approach, considering the information corresponding to each window and returning any possible ranges found from each window. Its specialized instructions guide it to prioritize recall over precision so as to give the reasoning agent as much information as possible.

Another example of a visual module is an ASR understanding module. When a video contains speech, it often contains critical context to the visual content of the video. This module takes a query and attempts to identify any relevant information from an automatic transcription of the speech in the video. If the transcript is too long for the context, it obtains information from each piece up to its context window, then tries to consolidate the information obtained from the different parts of the transcript.

One example of a module that does not operate on the context is a thinking module. This module allows the reasoning agent to perform a step of explicit verbal reasoning to plan its next tool use before proceeding. It allows the reasoning agent to use a step to reason instead of to use a tool and returns the text reasoning from the agent on how to proceed. That is, this tool can call the reasoning generative neural network with a prompt that includes context information and can instruct the reasoning generative neural network to generate a reasoning output for planning the next module to be called.

Another example of a module is a completion module, through which the agent indicates its final answer and ends the agentic inference procedure. By including the completion module in the set of modules and allowing the reasoning generative neural network 120 to generate an output that calls the completion module, the system 100 allows the reasoning generative neural network 120 to determine when it has accumulated sufficient information to generate the response, i.e., to dynamically determine when to terminate any given trajectory.

Generally, one or more of the modules make use of a neural network to generate their respective outputs. In some implementations, one or more of the modules can make use of the reasoning generative neural network 120, e.g., with a corresponding prompt that causes the generative neural network 120 to perform the required task. In some implementations, one or more of the modules can operate on the context data without using the generative neural network 120, e.g. by using a different, specially-trained neural network or by applying one or more statistical or heuristic-based algorithms to the context data to generate their respective outputs.

In some implementations, the system 100 generates one or more trajectories 122 that includes a respective program result at each of a plurality of iterations using the reasoning generative neural network 120. That is, at each iteration, the system 100 generates a program using the reasoning generative neural network 120 and then executes the program to generate a program result.

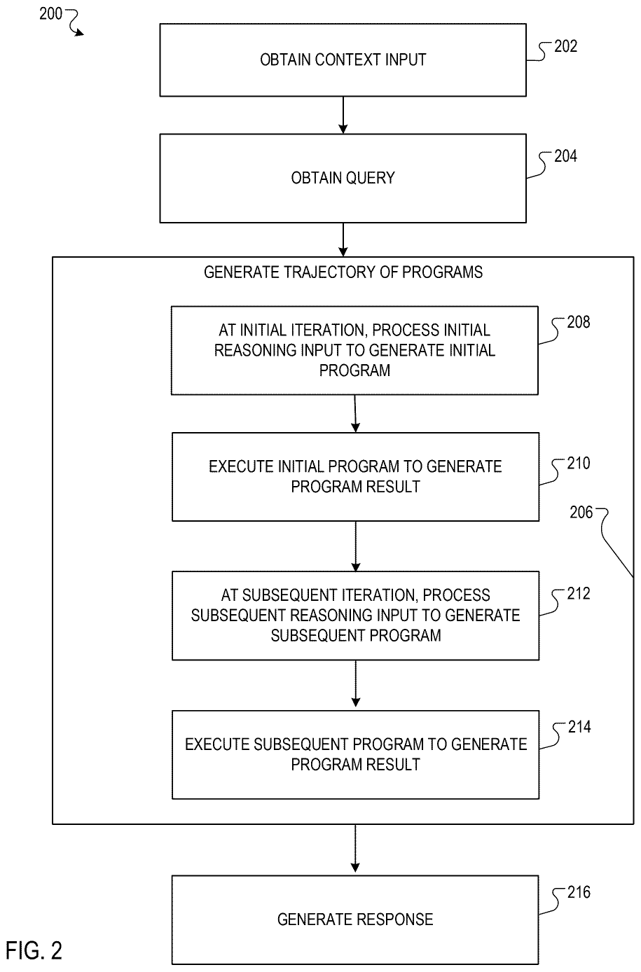

Generating trajectories using the reasoning generative neural network 120 will be described in more detail below with reference to FIG. 2.

The system 100 can then generate the response 112 using at least one of the program results in the trajectory. For example, the system 100 can generate the response 112 using the program result of the completion module.

Instead, the system 100 can use the critic generative neural network 130 to select between a set of trajectories that includes the trajectory 112 and one or more additional trajectories.

For example, in some implementations, the system 100 generates, using the reasoning generative neural network 120, a plurality of candidate trajectories that each include a respective program to be executed on the context input at each step of the trajectory. In some of these implementations, the candidate trajectories also include the corresponding program results. In others of these implementations, the candidate trajectories do not include corresponding program results or include placeholder or predicted program results generated by the reasoning generative neural network 120.

The system 100 then generates a critic input from the plurality of trajectories, e.g., by formatting the trajectories according to a specified format. The critic input can optionally include the query and further optionally a critic prompt, e.g., that includes in-context examples.

The system 100 processes the critic input using the critic generative neural network 130 to generate a critic output that indicates a preference among the candidate trajectories.

The system 100 selects a trajectory from among the candidate trajectories using the critic output, i.e., by selecting the candidate trajectory that is indicated as being preferred by the critic output.

The system 100 then generates a response to the query as a result of executing the respective programs in the selected trajectory. For example, after executing the respective programs, the system 100 can generate the response from the output of one or more of the programs, e.g., from the output of the program that calls the completion module or, more generally, the output of the last program in the trajectory.

Thus, the system 100 can use the reasoning generative neural network 120 to generate trajectories of programs and, in some cases, use the critic generative neural network 130 to select between the trajectories generated by the reasoning generative neural network 120 in order to effectively perform complex visual reasoning tasks.

FIG. 2 is a flow diagram of an example process 200 for generating a trajectory in response to a query using a reasoning generative neural network. For convenience, the process 200 will be described as being performed by a system of one or more computers located in one or more locations. For example, a neural network system, e.g., the neural network system 100 of FIG. 1, appropriately programmed in accordance with this specification, can perform the process 200.

The system obtains a context input that includes one or more images (step 202). For example, the context input can include a video.

The system obtains a query relating to the context input (step 204). For example, the query can be a text query or an audio query.

The system then generates a trajectory that includes a respective program result at each of multiple iterations (step 206).

In particular, at the initial iteration of the trajectory, the system can process an initial reasoning input that includes the query using a reasoning generative neural network to generate an initial reasoning output that defines an initial program that calls one or more modules from a plurality of modules that each operate on the context (step 208) and can then execute the initial program on the context input to generate the respective program result for the initial iteration (step 210).

That is, as described above, the system has access to a set of modules, at least some of which operate on the context input.

At the initial iteration of the trajectory, the system causes the reasoning generative neural network to generate, as output, a program by processing an input that includes the query.

The program can be a computer program in any appropriate programming language, e.g., Python, C++ or another appropriate language.

The system can execute the program, which includes calling the module specified in the program, by using an interpreter for the programming language, e.g., any appropriate Python interpreter.

To cause the reasoning generative neural network to generate the program, the system can include, in the input, data describing the modules that are available to the system, e.g., data describing the task performed by each of the modules and the format of inputs and outputs to the module. For example, the system can include, in the input and for each module, an API for the module in the form of Python function headers and docstrings. One example of such an input is shown below in Table 1:

TABLE 1

```
def find_when(query: str) -> str:
  ***
  Tool to determine timing of a query such as an
      event of action.
  Args:
    query (str): the event or action to localize.
  Returns:
    A string of time ranges identified as
        potentially relevant and the
        justification for each time range.
  ***
```

The input can also include a natural language instruction describing the task being performed by the reasoning generative neural network and instructing the neural network to format instructions as programs in the specified programming language.

At each subsequent iteration of the trajectory, the system can process a subsequent reasoning input that includes (i) the query, (ii) a respective program generated at a preceding iteration, and (iii) a respective program result from the preceding iteration using the reasoning generative neural network to generate a subsequent reasoning output that defines a subsequent program that calls one or more of the modules (step 212).

The system then executes the subsequent program. At some or all of the subsequent iterations, module being called can operate on the context input. In these cases, the system then executes the subsequent program on the context input to generate the respective program result for the subsequent iteration (step 214).

At each subsequent iteration, the system can determine, from the subsequent reasoning output, whether to terminate the trajectory after the subsequent iteration or to perform another iteration after the subsequent iteration. For example, the system can continue performing subsequent iterations until the subsequent program at a given iteration calls the completion module. In this example, the system can terminate the trajectory after executing the subsequent program that calls the completion module.

In some implementations, the system generates a response to the query based on at least one program result in the trajectory (step 216). For example, the system can generate the response as the output of the subsequent program that calls the completion module.

In some other implementations, the system generates multiple candidate trajectories, e.g., the trajectory described above and one or more additional trajectories. For example, to generate each of the trajectories, the system can perform a respective iteration of steps 206-214.

In some implementations, the system performs each iteration of steps 206-214 with the same set of available modules, relying on the stochastic nature of generative neural network decoding to yield diverse candidate trajectories.

In some other implementations, the system performs multiple iterations of steps 206-214, with some or all of the iterations having different sets of available modules, e.g., different, randomly-selected subsets of a larger set of modules. This can encourage the generative neural network to generate diverse candidate trajectories.

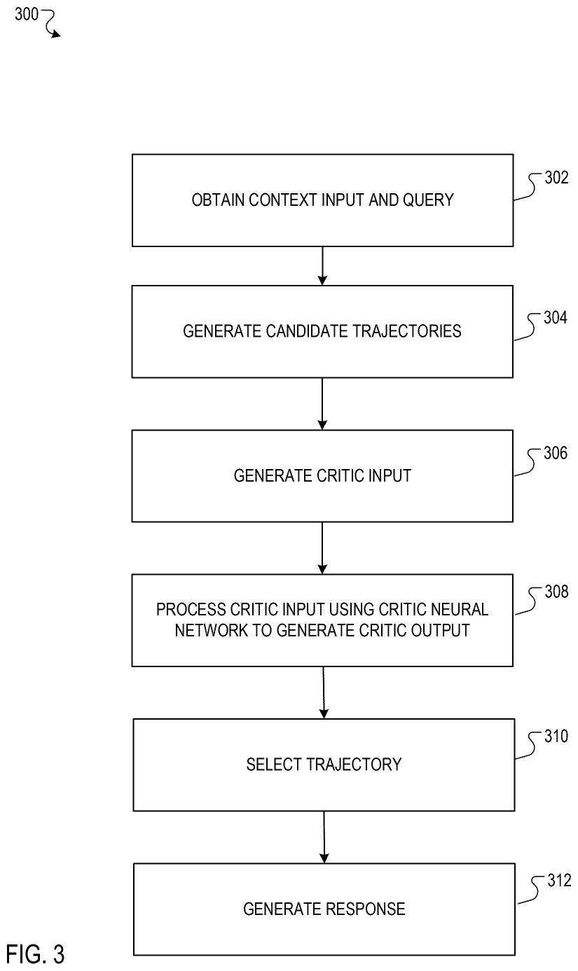

The system can then use the critic neural network to select between the candidate trajectories. This will be described in more detail below with reference to FIG. 3.

FIG. 3 is a flow diagram of an example process 300 for generating a response to the query using a critic neural network. For convenience, the process 300 will be described as being performed by a system of one or more computers located in one or more locations. For example, a neural network system, e.g., the neural network system 100 of FIG. 1, appropriately programmed in accordance with this specification, can perform the process 300.

The system obtains a context input and a query relating to the context input (step 302).

The system generates, using a reasoning generative neural network, a plurality of candidate trajectories that each include a respective program to be executed on the context input (step 304).

For example, the system can generate each candidate trajectory by performing a respective iteration of steps 206-214 as described above with reference to FIG. 2.

The system generates a critic input from the plurality of trajectories (step 306). For example, the system can generate the critic input by formatting the trajectories according to a specified format. The critic input can optionally include the query and further optionally a critic prompt, e.g., that includes in-context examples.

For example, the critic input can prompt the critic neural network to critique the given trajectories and identify any that could be considered ‘winning strategies.’ Instead or in addition, the system can include a small number of in-context examples in the critic input. Each in-context example is constructed with a question, each sampled strategy, an optional brief critique, and a list of the winning strategies. An example of an in-context example is shown below in Table 2:

TABLE 2

```
Question: When is the trampoline first used?
Strategy A:
(formatted reasoning traces)
[...]
Critique:
Strategies A and C actually perceive a person
  using the trampoline and pick the associated
  range. Strategy B only sees the finished
  trampoline and guesses based on that, but
  does not directly see the part relevant to
  the query.
Winning Strategies:
A, C
```

In some implementations, instead of or in addition to including a natural language instruction, in-context examples or both in the critic input, the system or another training system can have trained the critic neural network, e.g., starting from a pre-trained generative neural network. For example, the critic neural network can have been trained on training data that includes a plurality of training examples that each include data describing a respective set of example trajectories and an example critic output that indicates a preference between the respective set of example trajectories.

The system processes the critic input using the critic generative neural network to generate a critic output that indicates a preference among the candidate trajectories (step 308). For example, the critic output can identify a preferred candidate trajectory and, optionally, include a reasoning output that provides a natural language explanation of why the preferred candidate trajectory is preferred among all of the candidate trajectories.

The system selects a trajectory from among the candidate trajectories using the critic output (step 310). For example, the system can select the candidate trajectory that is identified as the preferred trajectory in the critic output.

The system generates a response to the query by executing the respective programs in the selected trajectory (step 312). In some implementations, the system has already executed the programs in the selected trajectory as part of generating the trajectory. In these implementations, the system generates the response from the already-generated outputs of the programs in the selected trajectory.

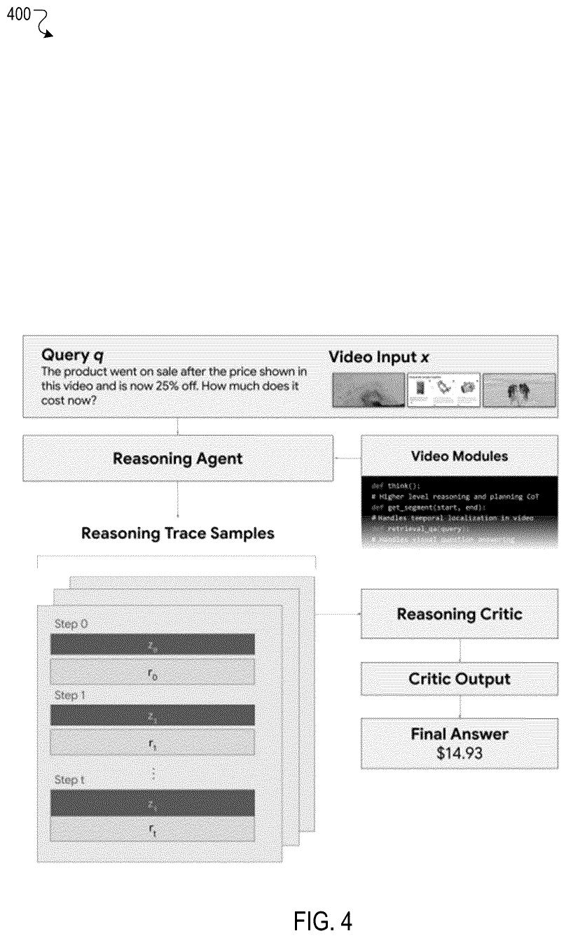

FIG. 4 shows an example 400 of the operation of the system 100.

In the example 400, the system receives a query q about a context input x. In this example, the context input x is a video.

The system 100 uses the reasoning generative neural network 120 to sample a set of multiple trajectories (also referred to as “reasoning traces”) by interacting with the set of modules.

Each trajectory includes a respective program z and a respective response r at each of multiple steps, e.g., steps 0 through t.

The system 100 then uses the critic generative neural network 130 to generate a critic output that indicates a preference among the generated trajectories and selects one of the trajectories using the critic output. The system 100 then uses selected trajectory to generate a final answer to the query q.

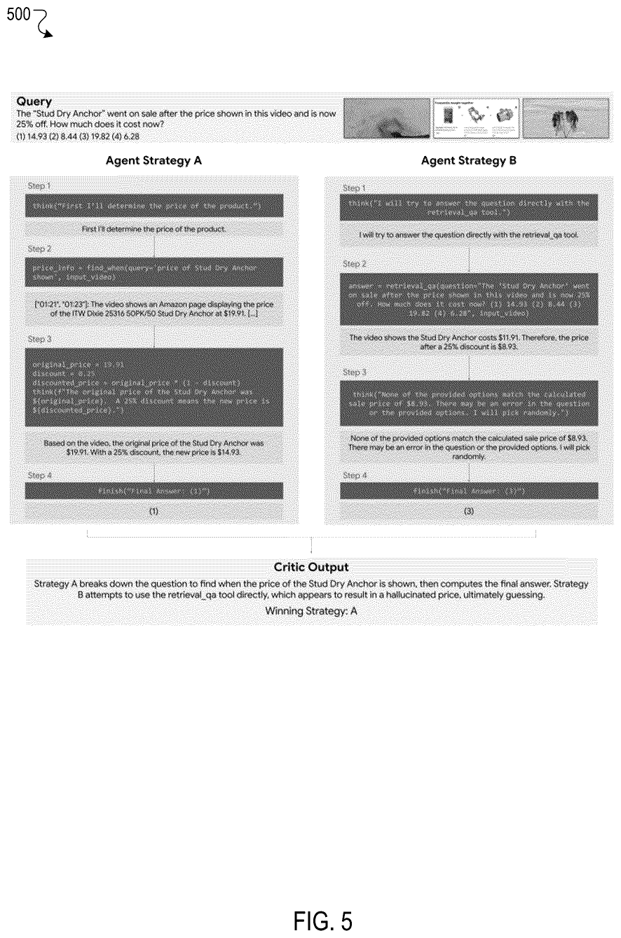

FIG. 5 shows an example 500 of using the critic generative neural network to select between two trajectories generated by the reasoning generative neural network.

In particular, in the example 500, the system has processed the query q and the video input x using the reasoning generative neural network to generate two trajectories A and B that yield different responses to the query.

The system then processes a critic input that includes the trajectories A and B using the critic neural network to generate a critic output that identifies the preferred trajectory (the “winning strategy”) as trajectory A and includes a natural language explanation of why trajectory A is preferred.

An example of architectures for the generative neural networks that can be employed as the reasoning generative neural network and the critic generative neural network now follows.

As a particular example, in some situations, the neural network can be referred to as an auto-regressive neural network, i.e., because the neural network auto-regressively generates an output sequence of tokens. More specifically, the auto-regressively generated output is created by generating each particular token in the output sequence conditioned on a current input sequence that includes any tokens that precede the particular token in the output sequence, i.e., the tokens that have already been generated for any previous positions in the output sequence that precede the particular position of the particular token.

In particular, to generate a particular token at a particular position within an output sequence, the neural network can process the current input sequence to generate a score distribution (e.g., a probability distribution) that assigns a respective score, e.g., a respective probability, to each token in a vocabulary of tokens. The neural network can then select, as the particular token, a token from the vocabulary using the score distribution. For example, the neural network can greedily select the highest-scoring token or can sample, e.g., using nucleus sampling or another sampling technique, a token from the distribution.

For example, the neural network can be an auto-regressive attention neural network that includes (i) a plurality of attention blocks that each apply a self-attention operation and (ii) an output subnetwork that processes an output of the last attention block to generate the score distribution.

In this example, the neural network can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d′Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training Gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; Gemini Team, et al. Gemini 1.5: Unlocking multimodal understanding across millions of tokens of context. arXiv preprint arXiv: 2403.05530 (2024); and Comanici, Gheorghe, et al. Gemini 2.5: Pushing the frontier with advanced reasoning, multimodality, long context, and next generation agentic capabilities. arXiv preprint arXiv: 2507.06261 (2025), Gemma Team, et al. Gemma 3 Technical Report arXiv preprint arXiv: 2503.19786 (2025).

More specifically, the neural network includes plurality of layers that include a plurality of attention layers.

Each attention layer receives a respective hidden state for each of the input positions and updates the respective hidden states for each of the input positions by applying an attention mechanism to the respective hidden states.

Generally, the task can be any task that requires generating an output sequence that includes a respective output token at each of multiple output positions. Examples of such tasks include computer code generation or editing tasks, text generation or editing tasks, image, video, or audio understanding tasks, and so on.

Some examples of machine learning tasks that a neural network when implemented using one of the architectures described above or other known architectures can be configured to perform follow.

In any of the implementations below, the neural network may be deployed as part of a chat bot, dialogue agent, or other software tool that receives input from users and provides outputs in response to the received input, e.g., as part of a conversation or dialogue. In these implementations, the input sequences received by the neural network are (generated from) user inputs and the output sequences generated by the neural network can be used to generate responses to the user inputs.

In implementations the neural network may be configured as, or include, a generative (large) language model or a multi-modal model, e.g., a visual and language model, to perform these example machine learning tasks.

In some cases, the neural network is a neural network that is configured to perform an image processing task, i.e., receive an input image and to process the input image to generate a network output for the input image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories. In some other cases, the neural network is a neural network that is configured to perform an image generation task, where the input is a conditioning input and the output is a sequence of intensity value inputs for the pixels of an image.

As one example, the task may be a neural machine translation task. For example, if the input to the neural network is a sequence of text, e.g., a sequence of words, phrases, characters, or word pieces, in one language, the output generated by the neural network may be a translation of the sequence of text into another language, i.e., a sequence of text in the other language that is a translation of the input sequence of text. The vocabulary for the input tokens may be words, wordpieces or characters of the first language, and the vocabulary for the output tokens may be words, wordpieces or characters of the other language. As a particular example, the task may be a multi-lingual machine translation task, where a single neural network is configured to translate between multiple different source language-target language pairs. In this example, the source language text may be augmented with an identifier that indicates the target language into which the neural network should translate the source language text.

Some implementations may be used for automatic code generation. For example, the input tokens may represent words, wordpieces or characters in a first natural language and the output tokens may represent instructions in a computer programming or markup language, or instructions for controlling an application program to perform a task e.g. build a data item such as an image or web page.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can be a classification of the spoken utterance into one of a plurality of categories, for example an identity of the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient. Such electronic health data may, for example, comprise one or more sequences of physiological data taken from a patient, with the output being a corresponding prediction that relates to those sequences of data. Examples of physiological data and a corresponding prediction include: blood glucose measurements, with the prediction being a predicted future blood glucose measurement or the prediction of a hyper- or hypo-glycemic event; a heart rate, with the prediction being the presence or absence of a heart condition, or a future cardiac event; blood pressure measurements, with the prediction being the risk of a future heart condition; or the like.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

In some implementations the input sequence represents data to be compressed, e.g. image data, text data, audio data, or any other type of data, and the output sequence a compressed version of the data. The input and output tokens may each comprise any representation of the data to be compressed/compressed data e.g. symbols or embeddings generated/decoded by a respective neural network.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent. The observations may comprise sensor data captured by sensors associated with (e.g. part of) the agent, for example visual data, LIDAR data, sonar data, agent configuration data (e.g. joint angles), agent orientation data, or the like.

In some implementations, the environment is a real-world environment, the agent is a mechanical (or electro-mechanical) agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example, in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the positions, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example captured by a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example, in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example, a system implementing the neural network may be used to select actions in the simulated environment during training or evaluation of the system and, after training, or evaluation, or both, are complete, the action selection policy may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example, the system may be partly trained using a simulation of a mechanical agent in a simulation of a particular real-world environment, and afterwards deployed to control the real mechanical agent in the particular real-world environment. Thus, in such cases the observations of the simulated environment relate to the real-world environment, and the selected actions in the simulated environment relate to actions to be performed by the mechanical agent in the real-world environment.

In some implementations, as described above, the agent may not include a human being (e.g. it is a robot). Conversely, in some implementations the agent comprises a human user of a digital assistant such as a smart speaker, smart display, or other device. Then the information defining the task can be obtained from the digital assistant, and the digital assistant can be used to instruct the user based on the task.

For example, a system implementing the neural network may output to the human user, via the digital assistant, instructions for actions for the user to perform at each of a plurality of time steps. The instructions may for example be generated in the form of natural language (transmitted as sound and/or text on a screen) based on actions chosen by the system. The system chooses the actions that contribute to performing a task. A monitoring system (e.g. a video camera system) may be provided for monitoring the action (if any) which the user actually performs at each time step, in case (e.g. due to human error) it is different from the action which the system instructed the user to perform. Using the monitoring system the system can determine whether the task has been completed. The system may identify actions which the user performs incorrectly with more than a certain probability. If so, when the system instructs the user to perform such an identified action, the system may warn the user to be careful. Alternatively or additionally, the system may learn not to instruct the user to perform the identified actions, i.e. ones which the user is likely to perform incorrectly.

More generally, the digital assistant instructing the user may comprise receiving, at the digital assistant, a request from the user for assistance and determining, in response to the request, a series of tasks for the user to perform, e.g. steps or sub-tasks of an overall task. Then for one or more tasks of the series of tasks, e.g. for each task, e.g. until the final task of the series, the digital assistant can be used to output to the user an indication of the task, e.g. step or sub-task, to be performed. This may be done using natural language, e.g. on a display and/or using a speech synthesis subsystem of the digital assistant. Visual, e.g. video, and/or audio observations of the user performing the task may be captured, e.g. using the digital assistant. A system as described above may then be used to determine whether the user has successfully achieved the task e.g. step or sub-task, i.e. from the answer as previously described. If there are further tasks to be completed the digital assistant may then, in response, progress to the next task (if any) of the series of tasks, e.g. by outputting an indication of the next task to be performed. In this way the user may be led step-by-step through a series of tasks to perform an overall task. During the training of the neural network, training rewards may be generated e.g. from video data representing examples of the overall task (if corpuses of such data are available) or from a simulation of the overall task.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g. a conversation agent such as Sparrow (Glaese et al. arXiv: 2209.14375) or Chinchilla (Hoffmann et al. arXiv: 2203.15556). The digital assistant can have an observation capture subsystem to capture visual and/or audio observations of the user performing a task; and an interface for the above-described neural network (which may be implemented locally or remotely). The digital assistant can also have an assistance control subsystem configured to assist the user. The assistance control subsystem can be configured to perform the steps described above, for one or more tasks e.g. of a series of tasks, e.g. until a final task of the series. More particularly the assistance control subsystem can output to the user an indication of the task to be performed, capture, using the observation capture subsystem, visual or audio observations of the user performing the task, determine from the above-described answer whether the user has successfully achieved the task. In response the digital assistant can progress to the next task of the series of tasks and/or control the digital assistant, e.g. to stop capturing observations.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

In some cases, the machine learning task is a multi-modal processing task that requires processing multi-modal data. In general, multi-modal data is a combination of two or more different types of data, e.g., two or more of audio data, image data, text data, or graph data. As one example, the multi-modal data may comprise audio-visual data, comprising a combination of pixels of an image or of video and audio data representing values of a digitized audio waveform. As another example the multi-modal data may comprise a combination of i) text data representing text in a natural language and ii) pixels of an image or of video or audio data representing values of an audio waveform. Optionally, but not necessarily, the different types of data may represent the same or overlapping objects using the different modalities (types), and when processing multi-modal data, the data may be mapped into a common embedding space.

As a particular example, the task is a multi-modal processing task that requires processing both text and image inputs, so that the neural network includes both a computer vision neural network and a text processing neural network. That is, the target output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

More generally, the multi-modal processing task may correspond to any of the tasks previously described for any of the types of data making up the multi-modal combination. For example, the accuracy of the previously described tasks may be increased when the task is applied to multi-modal data combining the data for which the task has been previously described and another type of data. For example, detection or classification of an object or event may be improved when data of multiple different types (modalities) is processed.

More generally, the task to be performed by the neural network can be specified by the input sequence. As a particular example, the input sequence can include a prompt or an instruction that specifies the task that is to be performed by the neural network. Optionally, in this example, the input sequence also includes context for performing the task.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard, touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining a context input that comprises one or more images;
obtaining a query relating to the context input;
generating a trajectory that comprises a respective program result at each of a plurality of iterations, the generating comprising:
at an initial iteration of the plurality of iterations:
processing an initial reasoning input that comprises the query using a reasoning generative neural network to generate an initial reasoning output that defines an initial program that calls one or more modules from a plurality of modules that each operate on the context input; and
executing the initial program on the context input to generate the respective program result for the initial iteration; and
at each of one or more subsequent iterations of the plurality of iterations:
processing a subsequent reasoning input that comprises (i) the query, (ii) a respective program generated at a preceding iteration, and (iii) a respective program result from the preceding iteration using the reasoning generative neural network to generate a subsequent reasoning output that defines a subsequent program that calls one or more of the modules; and
executing the subsequent program on the context input to generate the respective program result for the subsequent iteration; and
generating a response to the query based on at least one program result in the trajectory.

2. The method of claim 1, wherein the at least one program result comprises the last program result in the trajectory.

3. The method of claim 1, wherein generating a response to the query based on at least one program result in the trajectory comprises:
generating, using the reasoning generative neural network and from the query and the context input, one or more additional trajectories that each comprise a respective program result at each of a plurality of iterations;
generating a critic input from the trajectory and the one or more additional trajectories;
processing the critic input using a critic generative neural network to generate a critic output that indicates a preference among the trajectory and the one or more additional trajectories;
selecting a particular trajectory from among the trajectory and the one or more additional trajectories using the critic output; and
generating the response based on the at least one program result in the selected particular trajectory.

4. The method of claim 3, wherein the critic input comprises (i) the query and (ii) data describing the trajectory and the one or more additional trajectories.

5. The method of claim 4, wherein the critic input further comprises (iii) one or more in-context examples that each include data describing a respective set of example trajectories and an example critic output that indicates a preference between the respective set of example trajectories.

6. The method of claim 4, wherein the critic generative neural network has been trained on training data comprising a plurality of training examples that each include data describing a respective set of example trajectories and an example critic output that indicates a preference between the respective set of example trajectories.

7. The method of claim 3, wherein the trajectory further comprises, for each iteration, the program generated at the iteration.

8. The method of claim 1, wherein the context input comprises a video that includes a plurality of video frames.

9. The method of claim 1, wherein the context input comprises the one or more images and respective data having each of one or more other modalities.

10. The method of claim 9, wherein the respective data having each of the one or more other modalities comprises an audio signal.

11. The method of claim 1, wherein one or more of the modules process data representing the one or more images in the context input using a generative neural network.

12. The method of claim 11, wherein the generative neural network is the reasoning generative neural network.

13. The method of claim 11, wherein one or more of the modules operate on the context input without using the generative neural network.

14. The method of claim 1, wherein the generating further comprises, at each subsequent iteration of the plurality of iterations, determining from the subsequent reasoning output whether to terminate the trajectory after the subsequent iteration or to perform another iteration after the subsequent iteration.

15. A method performed by one or more computers, the method comprising:
obtaining a context input that comprises one or more images;
obtaining a query relating to the context input;
generating, using a reasoning generative neural network, a plurality of candidate trajectories that each comprise a respective program to be executed on the context input;
generating a critic input from the plurality of candidate trajectories;
processing the critic input using a critic generative neural network to generate a critic output that indicates a preference among the candidate trajectories;
selecting a trajectory from among the candidate trajectories; and
generating a response to the query by executing the respective programs in the selected trajectory.

16. The method of claim 15, wherein each of the plurality of candidate trajectories comprises a respective program result at one or more of a plurality of iterations.

17. The method of claim 16, wherein the respective program result is a predicted program result that is predicted to result from executing the respective program at the iteration.

18. The method of claim 1, wherein:
the initial reasoning input comprises data specifying the plurality of modules that each operate on the context, and
the subsequent reasoning input comprises data specifying the plurality of modules that each operate on the context.

19. The method of claim 1, wherein the response comprises a text response that describes one or more of: (i) one or more objects depicted in the context input; (ii) one or more events depicted in the context input; (iii) one or more actions that are performed by one or more agents depicted in the context input; and (iv) low-level features of one or more of the images in the visual context input.

20. A system comprising:
one or more computers; and
one or more storage devices communicatively coupled to the one or more computers, wherein the one or more storage devices store instructions that, when executed by the one or more computers, cause the one or more computers to perform operations comprising:
obtaining a context input that comprises one or more images;
obtaining a query relating to the context input;
generating a trajectory that comprises a respective program result at each of a plurality of iterations, the generating comprising:
at an initial iteration of the plurality of iterations:
processing an initial reasoning input that comprises the query using a reasoning generative neural network to generate an initial reasoning output that defines an initial program that calls one or more modules from a plurality of modules that each operate on the context input; and
executing the initial program on the context input to generate the respective program result for the initial iteration; and
at each of one or more subsequent iterations of the plurality of iterations:
processing a subsequent reasoning input that comprises (i) the query, (ii) a respective program generated at a preceding iteration, and (iii) a respective program result from the preceding iteration using the reasoning generative neural network to generate a subsequent reasoning output that defines a subsequent program that calls one or more of the modules; and
executing the subsequent program on the context input to generate the respective program result for the subsequent iteration; and
generating a response to the query based on at least one program result in the trajectory.
